(19) United States
(12) Patent Application Publication
(10) Pub. No.: US 2017/0041307 A1
(43) Pub. Date: Feb. 9, 2017

(54) IDENTITY AUTHENTICATION METHOD AND DEVICE

(71) Applicant: CHINA UNITED NETWORK COMMUNICATIONS GROUP COMPANY LIMITED, Beijing (CN)

(72) Inventors: Ni ZHANG, Beijing (CN); Yunyong ZHANG, Beijing (CN); Zhijun WANG, Beijing (CN); Di LIU, Beijing (CN); Yafei TANG, Beijing (CN)

(73) Assignee: CHINA UNITED NETWORK COMMUNICATIONS GROUP COMPANY LIMITED, Beijing (CN)

(21) Appl. No.: 15/230,059

(22) Filed: Aug. 5, 2016

(30) Foreign Application Priority Data
Aug. 7, 2015 (CN) 201510484932.2

(51) Int. Cl. H04L 29/06

(52) U.S. Cl. CPC H04L 63/08

(57) ABSTRACT

Embodiments of the present disclosure disclose an identity authentication method and device. The method comprises: receiving, by an identity authentication server, an identity authentication request transmitted by a third-party platform; determining, according to the phone number, an ID of a first identity authentication client by searching a pre-stored correspondence; if the first identity authentication client is online, transmitting a user information request; transmitting an authentication success message to the third-party platform if a user information response carrying the user information is received and the user information is consistent with user information stored in the identity authentication server; or transmitting an authentication fail message to the third-party platform if the user information is inconsistent with user information stored in the identity authentication server, or if a user information response carrying the user information is not received.

### CROSS-REFERENCE TO RELATED APPLICATION

The subject application claims priority to Chinese Patent Application No. 201510484932.2 filed Aug. 7, 2015. The subject matter of each is incorporated herein by reference in entirety.

### FIELD OF TECHNOLOGY

The present disclosure relates to the technical field of communication, and in particular to an identity authentication method and device.

### BACKGROUND

With rapid development of mobile internet, communication services such as calls can no longer meet requirements from users. A user acquiring data and services by a mobile terminal, mainly by a cell phone, becomes the tendency of the development of mobile internet services. At present, mobile internet services mainly represented by mobile browsing, mobile searching, mobile games, mobile socializing, mobile payment, mobile banking and the like provide users with more services which are convenient and fast. It can be foreseen that, as technologies such as LTE (short for Long Term Evolution) technology and e-commerce technology are becoming mature and widespread, the mobile internet services have a broad prospect of development.

In order to ensure the security of mobile internet services, identity authentication is performed on a user first before the user experiences a mobile internet service. Identity authentication is a process in which whether the identity of a user is consistent with the identity claimed by the user or not is reliably authenticated. Upon a successful identity authentication process, the user can experience a corresponding service. At present, there are mainly two common methods for identity authentication. One method is a “user name+password+message authentication code” identity authentication method where, in order to prevent the problem of insecurity resulted from leakage of user names, passwords and message authentication codes, it is generally necessary for a user to set different user names and passwords for different third-network platforms (i.e., a platform necessary to be logged in for mobile internet services); and furthermore, the more complex the user name and the password are, and the higher the security is. The other method is an identity authentication method based on an SIM (short for Subscriber Identity Module) card application where it is necessary to download an SIM card application to an SIM card in the form a text message; four groups of 03.48 keys defined by the European Telecommunications Standards Institute (ETSI in short) are stored in the SIM card application, and a group of keys are selected by the SIM card application and a mobile operator through negotiation to encrypt a same random number; and identity authentication is performed on a user by comparing whether the result of encryption of the random number by the SIM card application is consistent with the result of encryption of the random number by a server of the mobile operator or not.

However, the above-mentioned methods have the following problems. With regard to the “user name+password+message authentication code” identity authentication method, it is necessary for a user to remember a large amount of complex user names and passwords, thus leading to a poor user experience. With regard to the identity authentication method based on an SIM card application, it is necessary to download an SIM card application in the form of a text message. An SIM card application is generally 2 KB (kilobyte) to 7 KB, while at most 70 bytes can be downloaded by a text message. In this way, when this method is employed, 30 to 100 text messages are to be transferred in an error-free manner, and thus the efficiency is too low.

### SUMMARY OF THE DISCLOSURE

In a first aspect of the embodiments of the present disclosure, an identity authentication method is provided, applied in the process when a user logs in a third-party platform, including:

receiving, by an identity authentication server, an identity authentication request including a phone number of a user transmitted by a third-party platform;

determining, by the identity authentication server, according to the phone number, an ID of a first identity authentication client by searching a pre-stored correspondence between a phone number and an ID of an identity authentication client, the ID of the first identity authentication client being an ID of an identity authentication client corresponding to the phone number;

transmitting, by the identity authentication server, if the first identity authentication client is online, a user information request which is used to indicate that the user is logging in the third-party platform and to request the first identity authentication client to report user information to the first identity authentication client, the user information being used to indicate communication circumstance of the user within a preset period of time; and

transmitting, by the identity authentication server, an authentication success message to the third-party platform if the identity authentication server receives a user information response carrying the user information reported by the first identity authentication client and the user information carried in the user information response is consistent with user information stored in the identity authentication server; transmitting, by the identity authentication server, an authentication fail message to the third-party platform if the identity authentication server receives a user information response carrying the user information reported by the first identity authentication client and the user information carried in the user information response is inconsistent with user information stored in the identity authentication server, or if the identity authentication server fails to receive a user information response carrying the user information reported by the first identity authentication client.

In a second aspect of the embodiments of the present disclosure, an identity authentication method is provided, applied in the process when a user logs in a third-party platform, including:

receiving, by the first identity authentication client, a user information request which is used to indicate that the user is logging in the third-party platform and to request the first identity authentication client to report user information transmitted by the identity authentication server, the user information being used to indicate communication circumstance of the user within a preset period of time; and

reporting, by the first identity authentication client, a user information response carrying the user information if the first identity authentication client receives a confirm operation from the user so as to instruct the identity authentication server to perform identity authentication on the user according to the user information carried in the user information response.

In a third aspect of the embodiments of the present disclosure, an identity authentication server is provided, applied in the process when a user logs in a third-party platform, including:

a receiver configured to receive an identity authentication request including a phone number of a user transmitted by a third-party platform;

a memory configured to store programs;

a processor configured to read programs in the memory and perform the following operations: determining an ID of the first identity authentication client by searching a pre-stored correspondence between a phone number and an ID of the identity authentication client, the ID of the first identity authentication client being an ID of an identity authentication client corresponding to the phone number;

a transmitter configured to, if the first identity authentication client is online, transmit a user information request which is used to indicate that the user is logging in the third-party platform and to request the first identity authentication client to report user information to the first identity authentication client, the user information being used to indicate communication circumstance of the user within a preset period of time;

the receiver is also configured to receive a user information response carrying the user information reported by the first identity authentication client; and

the transmitter is also configured to: transmit an authentication success message to the third-party platform if the receiver receives a user information response carrying the user information reported by the first identity authentication client and the user information carried in the user information response is consistent with user information stored in the identity authentication server; transmit an authentication fail message to the third-party platform if the receiver receives a user information response carrying the user information reported by the first identity authentication client and the user information carried in the user information response is inconsistent with user information stored in the identity authentication server, or if the identity authentication server fails to receive a user information response carrying the user information reported by the first identity authentication client.

In a fourth aspect of the embodiments of the present disclosure, an identity authentication client is provided, applied in the process when a user logs in a third-party platform, including:

a receiver configured to receive a user information request, transmitted by the identity authentication server, which is used to indicate that the user is logging in the third-party platform and to request the first identity authentication client to report user information, the user information being used to indicate communication circumstance of the user within a preset period; and

a transmitter configured to report a user information response carrying the user information to the identity authentication server if the first identity authentication client receives a confirm operation from the user so as to instruct the identity authentication server to perform identity authentication on the user according to the user information carried in the user information response.

### BRIEF DESCRIPTION OF THE DRAWINGS

To describe the technical solutions in embodiments of the present invention or in the prior art more clearly, the accompanying drawings to be used for describing the embodiments will be introduced simply. Apparently, the accompanying drawings to be described below merely show some embodiments of the present invention, and those skilled in the art may further obtain other drawings according to these drawings without paying any creative effort.

FIG. 1 is a flowchart of an identity authentication method according to one embodiment of the present disclosure;

FIG. 2 is a flowchart of an identity authentication method according to another embodiment of the present disclosure;

FIG. 3 is a flowchart of an identity authentication method according to still another embodiment of the present disclosure;

FIG. 4 is a flowchart of an identity authentication method according to yet another embodiment of the present disclosure;

FIG. 5 is a schematic constitution diagram of an identity authentication server according to one embodiment of the present disclosure;

FIG. 6 is a schematic constitution diagram of an identity authentication client according to one embodiment of the present disclosure;

FIG. 7 is a schematic constitution diagram of an identity authentication client according to another embodiment of the present disclosure; and

FIG. 8 is a schematic constitution diagram of an identity authentication system according to one embodiment of the present disclosure.

### DETAILED DESCRIPTION OF THE PREFERRED EMBODIMENTS

Technical solutions in the embodiments of the present invention will be described clearly and completely with reference to the accompanying drawings in the embodiments of the present invention. Apparently, the embodiments to be described are merely some but not all embodiments of the present disclosure. Based on the embodiments of the present disclosure, all the other embodiments obtained by a person of ordinary skill in the art without paying any creative effort shall fall into the protection scope of the present disclosure.

### Embodiment 1

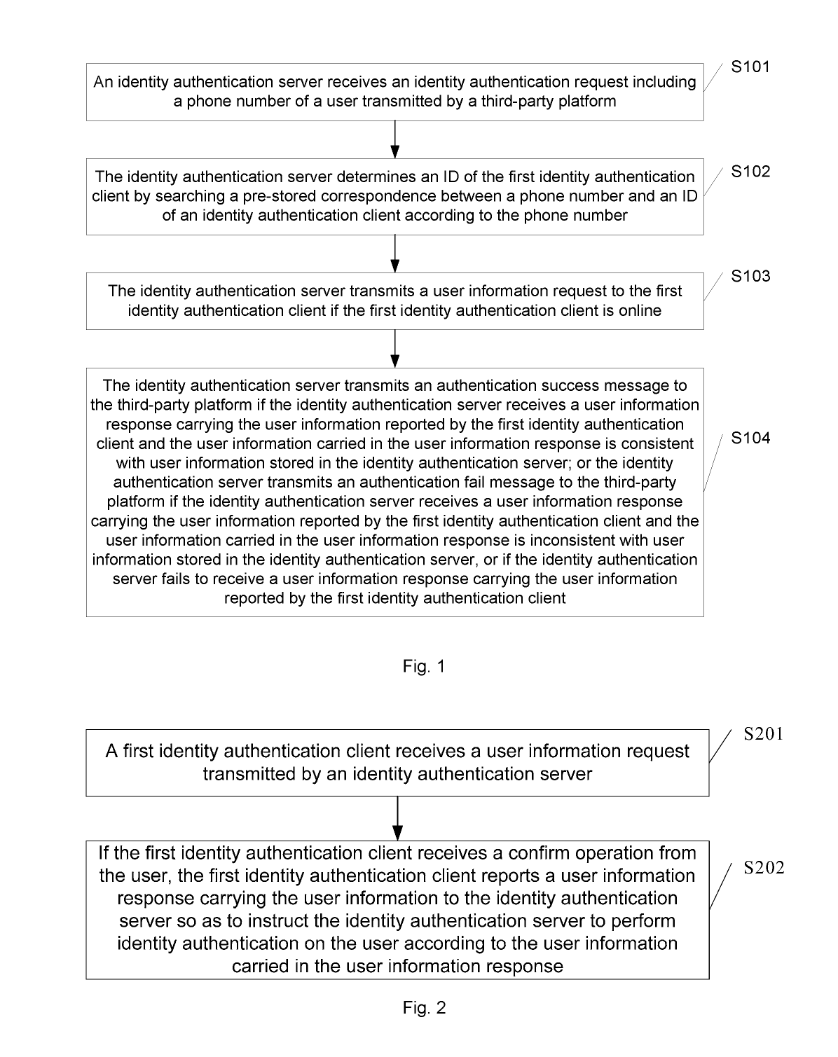

The embodiment of the present disclosure provides an identity authentication method applied in the process when a user logs in a third-party platform. As shown in FIG. 1, the identity authentication method includes the following steps.

S101: An identity authentication server receives an identity authentication request including a phone number of a user transmitted by a third-party platform.

Wherein, the phone number included in the identity authentication request is a phone number that a user inputs when logging in a third-party platform. The identity authentication server is a server set by a mobile operator and used to perform identity authentication on a user. The third-party platform is a platform necessary for a user to log in for internet services. For example, the third-party platform can be Wechat, QQ, Taobao, and a game website and the like.

S102: The identity authentication server determines an ID of the first identity authentication client by searching a pre-stored correspondence between a phone number and an ID of an identity authentication client according to the phone number.

Wherein, the ID of the first identity authentication client is an ID of the identity authentication client corresponding to the phone number. The first identity authentication client is a client installed in a user's mobile terminal and used to perform identity authentication on a user.

S103: The identity authentication server transmits a user information request to the first identity authentication client if the first identity authentication client is online.

Wherein, when the first identity authentication client is online, it is indicated that the identity authentication server can communicate with the first identity authentication client. A connection between the identity authentication server and the first identity authentication client can be established by HTTPS (short for Hyper Text Transfer Protocol over Secure Socket Layer), and the communicated content is encrypted by a shared key. Of course, a connection between the identity authentication server and the first identity authentication client can also be established by other secure transfer protocols, and is not limited in the embodiment of the present disclosure.

The user information request is used to indicate that a user is logging in a third-party platform and to request the first identity authentication client to report user information, and the user information is used to indicate communication circumstance of the user within a preset period of time. Specifically, the communication circumstance of a user within a preset period of time can be the history of calls and the number of times of outgoing calls and incoming calls of a user within a preset period of time, and is not limited in the embodiment of the present disclosure.

S104: The identity authentication server transmits an authentication success message to the third-party platform if the identity authentication server receives a user information response carrying the user information reported by the first identity authentication client and the user information carried in the user information response is consistent with user information stored in the identity authentication server; or the identity authentication server transmits an authentication fail message to the third-party platform if the identity authentication server receives a user information response carrying the user information reported by the first identity authentication client and the user information carried in the user information response is inconsistent with user information stored in the identity authentication server, or if the identity authentication server fails to receive a user information response carrying the user information reported by the first identity authentication client.

Wherein, the identity authentication server pre-stores user information of each user, which is obtained by the identity authentication server through a base station. If the user information carried in the user information response is consistent with the user information stored in the identity authentication server, it is indicated that the identity of the user is consistent with the identity claimed by the user. Thus, the identity authentication server succeeds in performing identity authentication on the user. In this case, the identity authentication server transmits an authentication success message to the third-party platform. Upon receiving the authentication success message, the third-party platform permits the user to log in and to perform the next operation. If the user information carried in the user information response is inconsistent with the user information stored in the identity authentication server, it is indicated that the identity of the user is inconsistent with the identity claimed by the user. Thus, the identity authentication server fails to perform identity authentication on the user. Or, if the identity authentication server fails to receive a user information response carrying the user information reported by the first identity authentication client, the identity authentication server fails to perform identity authentication on the user. In this case, the identity authentication server transmits an authentication fail message to the third-party platform. Upon receiving the authentication fail message, the third-party platform bans the user from logging in and from performing the next operation.

The identity authentication method according to the embodiment of the present disclosure includes: receiving, by an identity authentication server, an identity authentication request transmitted by a third-party platform; determining, according to the phone number included in the identity authentication request, an ID of a first identity authentication client by searching a pre-stored correspondence between a phone number and the identity authentication client; if the first identity authentication client is online, transmitting a user information request to the first identity authentication client; transmitting, by the identity authentication server, an authentication success message to the third-party platform if the identity authentication server receives a user information response carrying the user information reported by the first identity authentication client and the user information carried in the user information response is consistent with user information stored in the identity authentication server; transmitting, by the identity authentication server, an authentication fail message to the third-party platform if the identity authentication server receives a user information response carrying the user information reported by the first identity authentication client and the user information carried in the user information response is inconsistent with user information stored in the identity authentication server, or if the identity authentication server fails to receive a user information response carrying the user information reported by the first identity authentication client.

Compared with the “user name+password+message authentication code” identity authentication method in the prior art, in this solution, it is unnecessary for the user to remember a large amount of complex user names and passwords. The identity authentication process is completed by the identity authentication server as long as the third-party platform provides the identity authentication server with phone numbers. Thus, the problem of poor experience due to the necessity of remembering a large amount of complex user names and passwords can be avoided. Compared with the identity authentication method based on an SIM card application in the prior art, in this solution, it is unnecessary to download any SIM card application, and the identity authentication may be performed by installing an identity authentication client in a mobile terminal. Since the user information is used to indicate the communication circumstance of the user within a preset period of time, the user information may be easily obtained by both the identity authentication server and the identity authentication client. Hence, the use of this solution can improve the efficiency of identity authentication.

### Embodiment 2

The embodiment of the present disclosure provides an identity authentication method applied in the process when a user logs in a third-party platform. As shown in FIG. 2, the identity authentication method includes the following steps.

S201: A first identity authentication client receives a user information request transmitted by an identity authentication server.

Wherein, the first identity authentication client is a client installed in a user's mobile terminal and used to perform identity authentication on a user. The identity authentication server is a server set by a mobile operator and used to perform identity authentication on a user. The user information request is used to indicate that a user is logging in a third-party platform and to request the first identity authentication client to report user information, and the user information is used to indicate communication circumstance of the user within a preset period of time.

S202: If the first identity authentication client receives a confirm operation from the user, the first identity authentication client reports a user information response carrying the user information to the identity authentication server so as to instruct the identity authentication server to perform identity authentication on the user according to the user information carried in the user information response.

Wherein, the first identity authentication client can interact with the user. In the process when a user is logging in a third-party platform, when the first identity authentication client receives a user information request transmitted by the identity authentication server, the first identity authentication client can wait for a confirm operation from a user, the confirm operation being used to indicate that the user is actually logging in the third-party platform. If the first identity authentication client receives a confirm operation from a user, the first identity authentication client reports a user information response carrying the user information. If the first identity authentication client fails to receive a confirm operation from a user, the first identity authentication client does not report a user information response carrying the user information. When a phone number of a user is stolen by others for logging in, the user may not perform the confirm operation.

Exemplarily, after the first identity authentication client receives a user information request transmitted by the identity authentication server, a message window can be popped out, and in the message window, words the user is logging in the third-party platform” are displayed, or words “whether to transmit a user information response or not” are displayed. Two buttons “Yes” and “No” are further included in this message window. By clicking the button “Yes”, the user can perform the confirm operation. Of course, the user can also perform the confirm operation by clicking the button “Transmit” in the first identity authentication client. The user can also perform the confirm operation in the form of a text message. The way for a user to perform a confirm operation is not limited in the embodiment of the present disclosure.

With regard to the identity authentication method according to the embodiment of the present disclosure, the first identity authentication client reports a user information response carrying user information to the identity authentication server so as to instruct the identity authentication server to perform identity authentication on the user according to the user information carried in the user information response. Compared with the “user name+password+message authentication code” identity authentication method in the prior art, in this solution, it is unnecessary for the user to remember a large amount of complex user names and passwords. The identity authentication process is completed by the identity authentication server and the identity authentication client, and the problem of poor experience due to the necessity of remembering a large amount of complex user names and passwords can be avoided. Compared with the identity authentication method based on an SIM card application in the prior art, in this solution, it is unnecessary to download any SIM card application, and the identity authentication may be performed by installing an identity authentication client in a mobile terminal. Since the user information is used to indicate the communication circumstance of the user within a preset period of time, the user information may be easily obtained by both the identity authentication server and the identity authentication client. Hence, the use of this solution can improve the efficiency of identity authentication.

### Embodiment 3

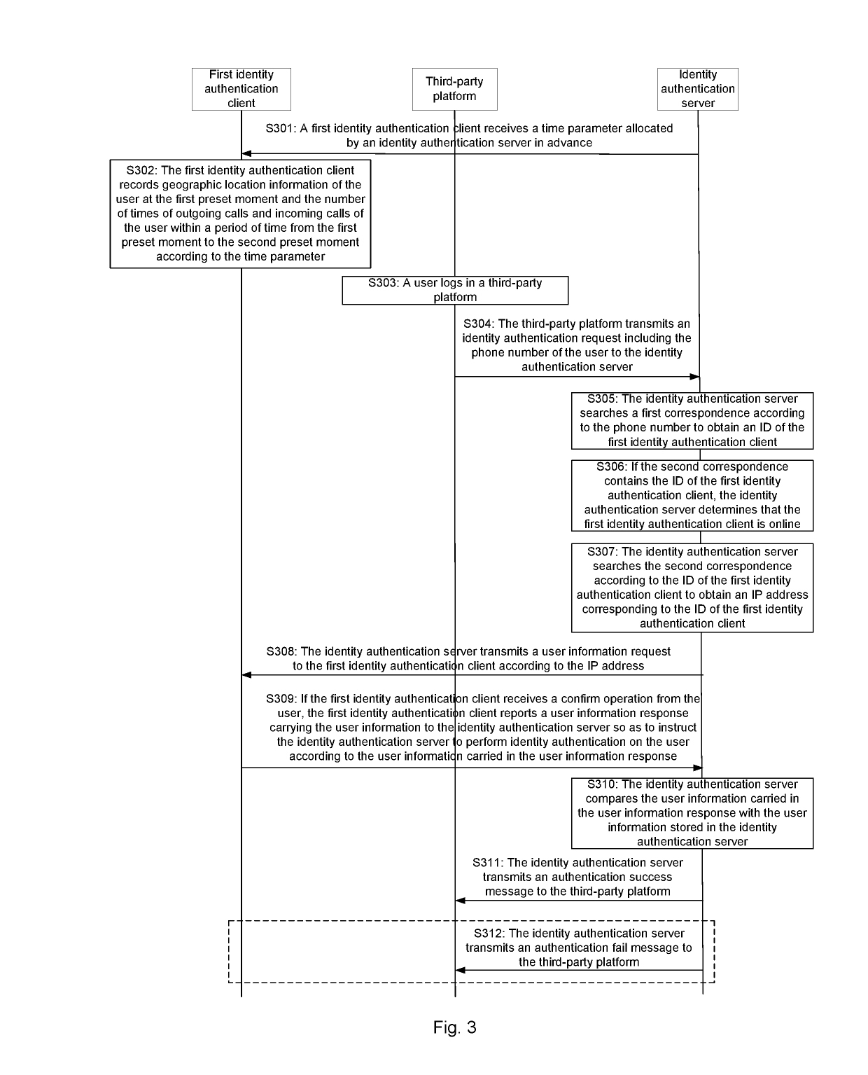

The embodiment of the present disclosure provides an identity authentication method applied in the process when a user logs in a third-party platform. As shown in FIG. 3, the identity authentication method includes the following steps.

S301: A first identity authentication client receives a time parameter allocated by an identity authentication server in advance.

Wherein, the first identity authentication client is a client installed in a user's mobile terminal and configured to perform identity authentication on a user. The identity authentication server is a server set by a mobile operator and used to perform identity authentication on a user.

The time parameter includes a first preset moment t1 and a second preset moment t2. Both t1 and t2 can be time parameters generated by the identity authentication server randomly. As for different identity authentication clients, the identity authentication server can allocate different t1 and t2. The first identity authentication client can receive, when enabled for the first time every day, a time parameter allocated by the identity authentication server in advance. The time parameters received by the first identity authentication client every day can be different.

S302: The first identity authentication client records geographic location information of the user at the first preset moment and the number of times of outgoing calls and incoming calls of the user within a period of time from the first preset moment to the second preset moment according to the time parameter.

Wherein, the first identity authentication client can obtain geographic location information of the user at the first moment by a GPS (short for Global Positioning System).

Exemplarily, assuming that t1 is 8:00 and t2 is 9:00, then, the first identity authentication client is required to record geographic location information of the user at 8:00 and record the number of times of outgoing calls and incoming calls of the user within a period of time from 8:00 to 9:00. The geographic location information of the user at 8:00 is specifically the geographic location information of the user's mobile terminal at 8:00. The number of times of outgoing calls and incoming calls of the user within a period of time from 8:00 to 9:00 is specifically the number of times of outgoing calls and incoming call of the user's phone number within a period of time from 8:00 to 9:00.

S303: A user logs in a third-party platform.

When a user is going to log in a third-party platform, the user only needs to input a phone number in the third-party platform and wait for the identity authentication server to perform identity authentication on the user.

S304: The third-party platform transmits an identity authentication request including the phone number of the user to the identity authentication server.

In this embodiment, the third-party platform carries a phone number of a user in an identity authentication request and transmits the identity authentication request to the identity authentication server which performs identity authentication on the user, while the third-party platform just waits for an authentication result returned by the identity authentication server.

S305: The identity authentication server searches a first correspondence according to the phone number to obtain an ID of the first identity authentication client.

Wherein, the ID of the first identity authentication client is an ID of the identity authentication client corresponding to the phone number. A first correspondence and a second correspondence are stored in the identity authentication server.

The first correspondence includes: the phone number of each user, as well as an ID of an identity authentication client corresponding to each phone number, an IMSI (short for International Mobile Subscriber Identification Number), an IMEI (short for International Mobile Equipment Identity), a first preset moment, a second preset moment, geographic location information of a user at the first preset moment, and the number of times of outgoing calls and incoming calls of a user within a period of time from the first preset moment to the second preset moment. The geographic location information of a user at a first preset moment corresponding to each phone number, and the number of times of outgoing calls and incoming calls of a user within a period of time from the first preset moment to the second preset moment are information acquired by the identity authentication server through a base station.

In this embodiment, a phone number corresponds to a user. An IMSI corresponding to a phone number is specifically an IMSI of a phone card corresponding to the phone number, wherein the phone card can be an SIM card or a UIM (short for User Identify Module) card and the like. An IMEI corresponding to a phone number is specifically an IMEI of the mobile terminal in which a phone card corresponding to the phone number is.

It should be noted that, every time after a new user installs an identity authentication client in a mobile terminal, the identity authentication server is required to record, in the first correspondence, a phone number of the new user and an ID of the newly-installed identity authentication client.

The second correspondence includes: an ID of an identity authentication client which is currently online and an IP (short for Internet Protocol) address corresponding to an ID of an identity authentication client which is currently online. The IP address here is specifically an IP address of a mobile terminal in which the identity authentication client is.

The first identity authentication client can transmit a keep-alive message to an identity authentication server periodically, so as to ensure normal communication between the identity authentication server and the first identity authentication client. If the identity authentication server can receive the keep-alive message transmitted by the first identity authentication client, it is indicated that normal communication between the identity authentication server and the first identity authentication client can be performed. The identity authentication server can record an ID of the first identity authentication client and the IP address corresponding to the ID of the first identity authentication client in the second correspondence, so as to indicate that the first identity authentication client is online.

S306: If the second correspondence contains the ID of the first identity authentication client, the identity authentication server determines that the first identity authentication client is online.

Wherein, when the first identity authentication client is online, it is indicated that the identity authentication server can communicate with the first identity authentication client.

S307: The identity authentication server searches the second correspondence according to the ID of the first identity authentication client to obtain an IP address corresponding to the ID of the first identity authentication client.

S308: The identity authentication server transmits a user information request to the first identity authentication client according to the IP address.

Wherein, the user information request is used to indicate that a user is logging in a third-party platform and to request the first identity authentication client to report user information, the user information being used to indicate communication circumstance of the user within a preset period of time.

Specifically, user information includes: at least one of an ID of the first identity authentication client, an IMSI of the user and an IMEI of the user, as well as geographic location information of the user at the first preset moment and the number of times of outgoing calls and incoming calls of the user within a period of time from the first preset moment to the second preset moment.

S309: If the first identity authentication client receives a confirm operation from the user, the first identity authentication client reports a user information response carrying the user information to the identity authentication server so as to instruct the identity authentication server to perform identity authentication on the user according to the user information carried in the user information response.

It should be noted that, if, when the first identity authentication client receives a user information request, the first preset moment and the second preset moment of that day do not arrive, i.e., the first identity authentication client does not record user information of that day, the first identity authentication client can report the user information recorded in the previous day to the first identity authentication server so as to instruct the identity authentication server to perform identity authentication on the user according to the user information recorded in the previous day.

S310: The identity authentication server compares the user information carried in the user information response with the user information stored in the identity authentication server.

Wherein, the user information stored in the identity authentication server can be obtained by the first correspondence.

Specifically, if the user information carried in the user information response is consistent with the user information stored in the identity authentication server, the identity authentication server succeeds in performing identity authentication on the user, and thus S311 is executed. If the user information carried in the user information response is inconsistent with the user information stored in the identity authentication server, the identity authentication server fails to perform identity authentication on the user, and thus S312 is executed.

S311: The identity authentication server transmits an authentication success message to the third-party platform.

Upon receiving the authentication success message, the third-party platform permits the user to log in and to perform the next operation.

S312: The identity authentication server transmits an authentication fail message to the third-party platform.

Upon receiving the authentication fail message, the third-party platform bans the user from logging in and from performing the next operation.

It should be noted that, if the identity authentication server fails to perform identity authentication on a certain user continuously for N times, when the identity authentication server receives the identity authentication request including the phone number of the user transmitted by the third-party platform for the N+1 times, the identity authentication server no longer performs identity authentication, and instead, directly transmits an authentication fail message to the third-party platform. Wherein, N is a positive integer set in advance, for example, N can be 5.

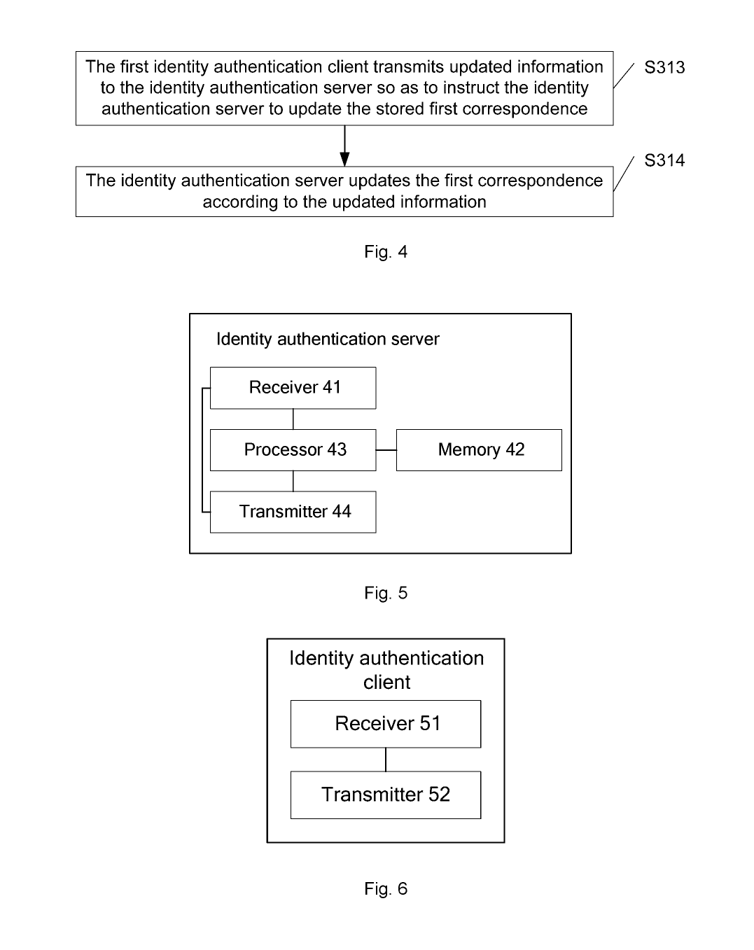

Further, as shown in FIG. 4, the identity authentication method in this embodiment can further include the following steps.

S313: The first identity authentication client transmits updated information to the identity authentication server so as to instruct the identity authentication server to update the stored first correspondence.

Wherein, the updated information includes: a phone number, an IMSI and an IMEI.

S314: The identity authentication server updates the first correspondence according to the updated information.

The steps of S313 to S314 can be performed after a user installs the first identity authentication client and before the step of S301. The steps of S313 to S314 can also be performed between the step of S301 and the step of S312. The steps of S313 to S314 can be performed once any one of the phone number, an IMSI and an IMEI of a user changes. The order to perform the steps of S313 to S314 and the steps of S301 to S312 is not limited in the embodiment of the present disclosure.

Compared with the “user name+password+message authentication code” identity authentication method in the prior art, the identity authentication method according to the embodiment of the present disclosure enables the user not to remember a large amount of complex user names and passwords. The identity authentication process is completed by the identity authentication server according to a phone number of a user, as long as the third-party platform provides the identity authentication server with the phone number. Thus, the problem of poor experience due to the necessity of remembering a large amount of complex user names and passwords can be avoided. Compared with the identity authentication method based on an SIM card application in the prior art, in this solution, it is unnecessary to download any SIM card application, and the identity authentication may be performed by installing an identity authentication client in a mobile terminal. Since the user information is used to indicate the communication circumstance of the user within a preset period of time, the user information may be easily obtained by both the identity authentication server and the identity authentication client. Hence, the use of this solution can improve the efficiency of identity authentication.

### Embodiment 4

The embodiment of the present disclosure provides an identity authentication server applied in the process when a user logs in a third-party platform. As shown in FIG. 5, the identity authentication server includes: a receiver 41, a memory 42, a processor 43 and a transmitter 44.

The receiver 41 is configured to receive an identity authentication request including a phone number of a user transmitted by a third-party platform.

The memory 42 is configured to store programs.

The processor 43 is configured to read programs in the memory 42 and perform the following operations: determining, according to a phone number received by the receiver 41, an ID of the first identity authentication client by searching a pre-stored correspondence between a phone number and an ID of the identity authentication client, the ID of the first identity authentication client being an ID of an identity authentication client corresponding to the phone number.

The transmitter 44 is configured to transmit, if the first identity authentication client is online, a user information request which is used to indicate that the user is logging in the third-party platform and to request the first identity authentication client to report user information to the first identity authentication client, the user information being used to indicate communication circumstance of the user within a preset period of time.

The receiver 41 is also configured to receive a user information response carrying the user information reported by the first identity authentication client.

The transmitter 44 is also configured to: transmit an authentication success message to the third-party platform if the receiver 41 receives a user information response carrying the user information reported by the first identity authentication client and the user information carried in the user information response is consistent with user information stored in the identity authentication server; transmit an authentication fail message to the third-party platform if the receiver 41 receives a user information response carrying the user information reported by the first identity authentication client and the user information carried in the user information response is inconsistent with user information stored in the identity authentication server, or if the receiver 41 fails to receive a user information response carrying the user information reported by the first identity authentication client.

Further, the user information includes: at least one of an ID of the first identity authentication client, an IMSI of the user and an IMEI of the user, as well as geographic location information of the user at a first preset moment and the number of times of outgoing calls and incoming calls of the user within a period of time from the first preset moment to a second preset moment, the first preset moment and the second preset moment being a time parameter allocated by the identity authentication server in advance.

Further, the memory 42 is also configured to store a first correspondence and a second correspondence; the first correspondence includes: the phone number of each user, as well as an ID of an identity authentication client corresponding to each phone number, an IMSI, an IMEI, a first preset moment, a second preset moment, geographic location information of a user at the first preset moment, and the number of times of outgoing calls and incoming calls of a user within a period of time from the first preset moment to the second preset moment all corresponding to each phone number; the second correspondence includes: an ID of an identity authentication client which is currently online and an IP address corresponding to an ID of an identity authentication client which is currently online.

Wherein, the geographic location information of a user at a first preset moment corresponding to each phone number, and the number of times of outgoing calls and incoming calls within a period of time from the first preset moment to a second preset moment corresponding to each phone number are information acquired by the identity authentication server through a base station.

Further, the receiver 41 is also configured to receive the updated information transmitted by the first identity authentication client. The updated information includes: a phone number, an IMSI and an IMEI.

Further, the processor 42 is also configured to update the first correspondence according to the updated information received by the receiver 41.

Further, the processor 43 is specifically configured to search the first correspondence according to the phone number to obtain an ID of the first identity authentication client.

The processor 43 is also configured to: determine that the first identity authentication client is online if the second correspondence contains the ID of the first identity authentication client; and search the second correspondence according to the ID of the first identity authentication client to obtain an IP address corresponding to the ID of the first identity authentication client.

The transmitter 44 is also configured to transmit a user information request to the first identity authentication client according to the IP address determined by the processor 43.

It should be noted that detailed description of some functional modules or parts in the identity authentication server according to the embodiment of the present disclosure can refer to corresponding content in the method embodiments, and will not be repeated here.

Compared with the “user name+password+message authentication code” identity authentication method in the prior art, the identity authentication server according to the embodiment of the present disclosure enables the user not to remember a large amount of complex user names and passwords. The identity authentication process is completed by the identity authentication server according to a phone number of a user, as long as the third-party platform provides the identity authentication server with the phone number. Thus, the problem of poor experience due to the necessity of remembering a large amount of complex user names and passwords can be avoided. Compared with the identity authentication method based on an SIM card application in the prior art, in this solution, it is unnecessary to download any SIM card application, and the identity authentication may be performed by installing an identity authentication client in a mobile terminal. Since the user information is used to indicate the communication circumstance of the user within a preset period of time, the user information may be easily obtained by both the identity authentication server and the identity authentication client. Hence, the use of this solution can improve the efficiency of identity authentication.

### Embodiment 5

The embodiment of the present disclosure provides an identity authentication client applied in the process when a user logs in a third-party platform. The client may be the first identity authentication client in the method embodiments.

As shown in FIG. 6, the identity authentication client includes a receiver 51 and a transmitter 52.

The receiver 51 is configured to receive a user information request, transmitted by the identity authentication server, which is used to indicate that the user is logging in the third-party platform and to request the first identity authentication client to report user information, the user information being used to indicate communication circumstance of the user within a preset period of time.

The transmitter 52 is configured to report a user information response carrying the user information to the identity authentication server if the first identity authentication client receives a confirm operation from the user so as to instruct the identity authentication server to perform identity authentication on the user according to the user information carried in the user information response.

Further, the user information includes: at least one of an ID of the first identity authentication client, an IMSI of the user and an IMEI of the user, as well as geographic location information of the user at a first preset moment and the number of times of outgoing calls and incoming calls of the user within a period of time from the first preset moment to a second preset moment, the first preset moment and the second preset moment being a time parameter allocated by the identity authentication server in advance.

Further, the receiver 51 is also configured to receive the time parameter allocated by the identity authentication server in advance.

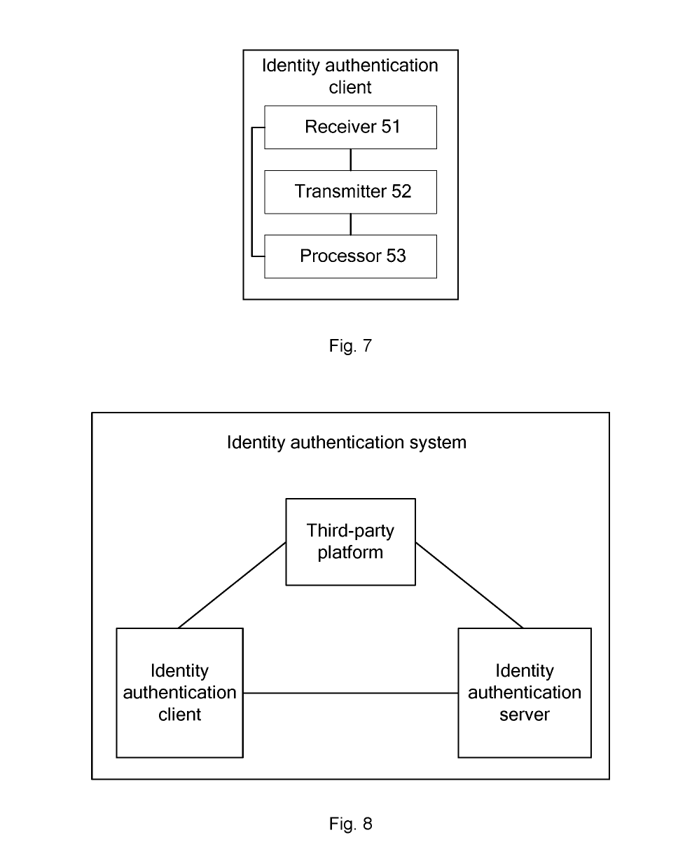

Further, as shown in FIG. 7, the identity authentication client also includes: a processor 53.

The processor 53 is configured to record geographic location information of the user at the first preset moment and the number of times of outgoing calls and incoming calls of the user within a period of time from the first preset moment and the second preset moment according to the time parameter.

Further, the transmitter 52 is also configured to transmit updated information to the identity authentication server so as to instruct the identity authentication server to update the stored first correspondence.

Wherein, the updated information includes: a phone number, an IMSI and an IMEI; the first correspondence includes: the phone number of each user, as well as an ID of an identity authentication client, an IMSI, an IMEI, a first preset moment, a second preset moment, geographic location information of a user at the first preset moment, and the number of times of outgoing calls and incoming calls of a user within a period of time from the first preset moment to the second preset moment all corresponding to each phone number.

It is to be noted that, the specific description of some functional modules or the parts of the identity authentication client according to the embodiment of the present disclosure may refer to corresponding contents in the method embodiments, and will not be repeated here.

Compared with the “user name+password+message authentication code” identity authentication method in the prior art, the identity authentication client according to the embodiment of the present disclosure enables the user not to remember a large amount of complex user names and passwords. The identity authentication process is completed by the identity authentication server and the identity authentication client. Thus, the problem of poor experience due to the necessity of remembering a large amount of complex user names and passwords can be avoided. Compared with the identity authentication method based on an SIM card application in the prior art, in this solution, it is unnecessary to download any SIM card application, and the identity authentication may be performed by installing an identity authentication client in a mobile terminal. Since the user information is used to indicate the communication circumstance of the user within a preset period of time, the user information may be easily obtained by both the identity authentication server and the identity authentication client. Hence, the use of this solution can improve the efficiency of identity authentication.

### Embodiment 6

The embodiment of the present disclosure provides an identity authentication system. As shown in FIG. 8, the identity authentication system includes a third-party platform, an identity authentication server as shown in FIG. 5, and any one of the identity authentication client in FIGS. 6 and 7. Wherein, the identity authentication server and the identity authentication client can perform the identity authentication method mentioned in the method embodiments, and will not be repeated here.

It can be clearly appreciated by those skilled in the art from the description of the implementations that, for ease of description and for simplicity, description has been given by taking the division of the functional modules as an example, and in practice, the functions may be completed by different function modules as needed, that is, the internal structure of the device is divided into different function modules to complete all or some of the functions as described above. The specific operating processes of the systems, devices and units described above may refer to corresponding processes of the method embodiments, and will not be repeated here.

In the several embodiments provided in the present application, it should be understood that the disclosed systems, devices and methods can be implemented in other ways. For example, the device embodiments described above are merely illustrative. For example, the division of the modules or units is merely logic division. In practice, there may be other divisions, for example, a plurality of units or assemblies may be combined or integrated into another system, or some features may be omitted or not executed. In addition, the displayed or discussed coupling or direct coupling or communicative connection between devices or units may be indirect coupling or communicative connection between devices or units by some interfaces or may be electrical connection, mechanical connection or connection in other forms.

The units described as separating components may or may not be physically separated. The components displayed as units may or may not physical units. That is, they may be in one location or distributed across a plurality of network units. Some or all of the units may be selected to implement the purpose of the solution of the embodiments as needed.

In addition, the functional units in the embodiments of the present disclosure may be integrated in one processing unit, or may be physically existed as individual units, or may be integrated in one unit by two or more. The integrated units may be implemented in the form of hardware or may be implemented in the form of software functional units.

The integrated units may, when implemented in the form of software functional units and sold or used as individual products, be stored in a computer-readable storage medium. On the basis of such understanding, the technical solution of the present disclosure or the portion contributing to the prior art or all or part of the technical solution may be embodied in the form of a software product. The computer software product is stored in a storage medium containing a number of instructions which cause a computer device (it may be a personal computer, a server, a network device, etc.) or a processor to execute all or part of steps of the method in the embodiments of the present disclosure. The storage medium includes various media capable of storing program codes, such as a USB flash disk, a removable hard disk, a read-only memory (ROM), a random access memory (RAM), a magnetic disk or an optical disk.

The foregoing descriptions are merely specific implementations of the present disclosure, and the protection scope of the present disclosure is not limited thereto. Any changes or replacements easily obtained by those skilled in the art shall be included within the protection scope of the present disclosure. Hence, the protection scope of the present disclosure is subject to the protection scope of the claims.

What is claimed is:

1. An identity authentication method, applied in the process when a user logs in a third-party platform, comprising:
receiving, by an identity authentication server, an identity authentication request including a phone number of a user transmitted by a third-party platform;
determining, by the identity authentication server, according to the phone number, an ID of a first identity authentication client by searching a pre-stored correspondence between a phone number and an ID of an identity authentication client, the ID of the first identity authentication client being an ID of an identity authentication client corresponding to the phone number;
transmitting, by the identity authentication server, if the first identity authentication client is online, a user information request which is used to indicate that the user is logging in the third-party platform and to request the first identity authentication client to report user information to the first identity authentication client, the user information being used to indicate communication circumstance of the user within a preset period of time; and
transmitting, by the identity authentication server, an authentication success message to the third-party platform if the identity authentication server receives a user information response carrying the user information reported by the first identity authentication client and the user information carried in the user information response is consistent with user information stored in the identity authentication server; transmitting, by the identity authentication server, an authentication fail message to the third-party platform if the identity authentication server receives a user information response carrying the user information reported by the first identity authentication client and the user information carried in the user information response is inconsistent with user information stored in the identity authentication server, or if the identity authentication server fails to receive a user information response carrying the user information reported by the first identity authentication client.

2. The identity authentication method according to claim 1, wherein the user information comprises: at least one of an ID of the first identity authentication client, an IMSI (International Mobile Subscriber Identification Number) of the user and an IMEI (International Mobile Equipment Identity) of the user, as well as geographic location information of the user at a first preset moment and the number of times of outgoing calls and incoming calls of the user within a period of time from the first preset moment to a second preset moment, the first preset moment and the second preset moment being a time parameter allocated by the identity authentication server in advance.

3. The identity authentication method according to claim 2, wherein a first correspondence and a second correspondence are stored in the identity authentication server; the first correspondence comprises: the phone number of each user, as well as an ID of an identity authentication client corresponding to each phone number, an IMSI, an IMEI, a first preset moment, a second preset moment, geographic location information of a user at the first preset moment, and the number of times of outgoing calls and incoming calls of a user within a period of time from the first preset moment to the second preset moment all corresponding to each phone number; the second correspondence comprises: an ID of an identity authentication client which is currently online and an IP (Internet Protocol) address corresponding to an ID of an identity authentication client which is currently online;
wherein the geographic location information of a user at a first preset moment corresponding to each phone number, and the number of times of outgoing calls and incoming calls within a period of time from the first preset moment to a second preset moment corresponding to each phone number are information acquired by the identity authentication server through a base station.

4. The identity authentication method according to claim 3, further comprising:
receiving, by the identity authentication server, updated information transmitted by the first identity authentication client, the updated information comprising a phone number, an IMSI and an IMEI; and
updating, by the identity authentication server, the first correspondence according to the updated information.

5. The identity authentication method according to claim 3, wherein
the determining, by the identity authentication server, an ID of the first identity authentication client by searching a pre-stored correspondence between a phone number and an ID of an identity authentication client comprises:
searching, by the identity authentication server, the first correspondence according to the phone number to obtain an ID of the first identity authentication client;
the transmitting, by the identity authentication server, a user information request to the first identity authentication client if the first identity authentication client is online comprises:
determining, by the identity authentication server, that the first identity authentication client is online if the second correspondence contains the ID of the first identity authentication client;
searching, by the identity authentication server, the second correspondence according to the ID of the first identity authentication client to obtain an IP address corresponding to the ID of the first identity authentication client; and
transmitting, by the identity authentication server, the user information request to the first identity authentication client according to the IP address.

6. An identity authentication method, applied in the process when a user logs in a third-party platform, comprising:
receiving, by a first identity authentication client, a user information request transmitted by the identity authentication server, which is used to indicate that the user is logging in the third-party platform and to request the first identity authentication client to report user information, the user information being used to indicate communication circumstance of the user within a preset period of time; and
reporting, by the first identity authentication client, a user information response carrying the user information to the identity authentication server if the first identity authentication client receives a confirm operation from the user so as to instruct the identity authentication server to perform identity authentication on the user according to the user information carried in the user information response.

7. The identity authentication method according to claim 6, wherein the user information comprises: at least one of an ID of the first identity authentication client, an IMSI (International Mobile Subscriber Identification Number) of the user and an IMEI (International Mobile Equipment Identity) of the user, as well as geographic location information of the user at a first preset moment and the number of times of outgoing calls and incoming calls of the user within a period of time from the first preset moment to a second preset moment, the first preset moment and the second preset moment being a time parameter allocated by the identity authentication server in advance.

8. The identity authentication method according to claim 7, further comprising:
receiving, by the first identity authentication client, the time parameter allocated by the identity authentication server in advance; and
recording, by the first identity authentication client, geographic location information of the user at the first preset moment and the number of times of outgoing calls and incoming calls of the user within a period of time from the first preset moment to the second preset moment according to the time parameter.

9. The identity authentication method according to claim 6, further comprising:
transmitting, by the first identity authentication client, updated information to the identity authentication server so as to instruct the first identity authentication server to update the stored first correspondence; and
wherein the updated information comprises: a phone number, an IMSI and an IMEI;
the first correspondence comprises: the phone number of each user, as well as an ID of an identity authentication client corresponding to each phone number, an IMSI, an IMEI, a first preset moment, a second preset moment, geographic location information of a user at the first preset moment, and the number of times of outgoing calls and incoming calls of a user within a period of time from the first preset moment to the second preset moment all corresponding to each phone number.

10. An identity authentication server, applied in the process when a user logs in a third-party platform, comprising:
a receiver configured to receive an identity authentication request including a phone number of a user transmitted by a third-party platform;
a memory configured to store programs;
a processor configured to read programs in the memory and perform the following operations: determining an ID of a first identity authentication client by searching a pre-stored correspondence between a phone number and an ID of the identity authentication client according to the phone number received by the receiver, the ID of the first identity authentication client being an ID of an identity authentication client corresponding to the phone number;
a transmitter configured to, if the first identity authentication client is online, transmit a user information request which is used to indicate that the user is logging in the third-party platform and to request the first identity authentication client to report user information to the first identity authentication client, the user information being used to indicate communication circumstance of the user within a preset period of time;
the receiver is also configured to receive a user information response carrying the user information reported by the first identity authentication client; and
the transmitter is also configured to: transmit an authentication success message to the third-party platform if the receiver receives a user information response carrying the user information reported by the first identity authentication client and the user information carried in the user information response is consistent with user information stored in the identity authentication server; transmit an authentication fail message to the third-party platform if the identity authentication server receives a user information response carrying the user information reported by the first identity authentication client and the user information carried in the user information response is inconsistent with user information stored in the identity authentication server, or if the receiver fails to receive a user information response carrying the user information reported by the first identity authentication client.

11. The identity authentication server according to claim 10, wherein the user information comprises: at least one of an ID of the first identity authentication client, an IMSI (International Mobile Subscriber Identification Number) of the user and an IMEI (International Mobile Equipment Identity) of the user, as well as geographic location information of the user at a first preset moment and the number of times of outgoing calls and incoming calls of the user within a period of time from the first preset moment to a second preset moment, the first preset moment and the second preset moment being a time parameter allocated by the identity authentication server in advance.

12. The identity authentication server according to claim 11, wherein the memory is also configured to store a first correspondence and a second correspondence; the first correspondence comprises: the phone number of each user, as well as an ID of an identity authentication client corresponding to each phone number, an IMSI, an IMEI, a first preset moment, a second preset moment, geographic location information of a user at the first preset moment, and the number of times of outgoing calls and incoming calls of a user within a period of time from the first preset moment to the second preset moment all corresponding to each phone number; and the second correspondence comprises: an ID of an identity authentication client which is currently online and an IP (Internet Protocol) address corresponding to an ID of an identity authentication client which is currently online; and
wherein the geographic location information of a user at a first preset moment corresponding to each phone number, and the number of times of outgoing calls and incoming calls within a period of time from the first preset moment to a second preset moment corresponding to each phone number are information acquired by the identity authentication server through a base station.

13. The identity authentication server according to claim 12, wherein the receiver is also configured to receive updated information transmitted by the first identity authentication client, the updated information comprising a phone number, an IMSI and an IMEI; and
the processor is also configured to update the first correspondence according to the updated information received by the receiver.

14. The identity authentication server according to claim 12, wherein the processor is specifically configured to search the first correspondence according to the phone number to obtain an ID of the first identity authentication client;
the processor is also configured to determine that the first identity authentication client is online if the second correspondence contains the ID of the first identity authentication client; and search the second correspondence according to the ID of the first identity authentication client to obtain an IP address corresponding to the ID of the first identity authentication client; and
the transmitter is also configured to transmit the user information request to the first identity authentication client according to the IP address determined by the processor.

15. An identity authentication client, applied in the process when a user logs in a third-party platform, comprising:
a receiver configured to receive a user information request, transmitted by a identity authentication server, which is used to indicate that the user is logging in the third-party platform and to request the first identity authentication client to report user information, the user information being used to indicate communication circumstance of the user within a preset period; and
a transmitter configured to report a user information response carrying the user information to the identity authentication server if the first identity authentication client receives a confirm operation from the user so as to instruct the identity authentication server to perform identity authentication on the user according to the user information carried in the user information response.

16. The identity authentication client according to claim 15, wherein the user information comprises: at least one of an ID of the first identity authentication client, an IMSI (International Mobile Subscriber Identification Number) of the user and an IMEI (International Mobile Equipment Identity) of the user, as well as geographic location information of the user at a first preset moment and the number of times of outgoing calls and incoming calls of the user within a period of time from the first preset moment to a second preset moment, the first preset moment and the second preset moment being a time parameter allocated by the identity authentication server in advance.

17. The identity authentication client according to claim 16, wherein the receiver is also configured to receive the time parameter allocated by the identity authentication server in advance;
the identity authentication client also comprises:
a processor configured to record geographic location information of the user at the first preset moment and the number of times of outgoing calls and incoming calls of the user within a period of time from the first preset moment and the second preset moment according to the time parameter.

18. The identity authentication client according to claim 15, wherein the transmitter is also configured to transmit updated information to the identity authentication server so as to instruct the identity authentication server to update the stored first correspondence; and
wherein the updated information comprises: a phone number, an IMSI and an IMEI; the first correspondence comprises: the phone number of each user, as well as an ID of an identity authentication client corresponding to each phone number, an IMSI, an IMEI, a first preset moment, a second preset moment, geographic location information of a user at the first preset moment, and the number of times of outgoing calls and incoming calls of a user within a period of time from the first preset moment to the second preset moment all corresponding to each phone number.
